(19) United States
(12) Patent Application Publication
(10) Pub. No.: US 2007/0052193 A1
(43) Pub. Date: Mar. 8, 2007

(54) Suspension member retention feature

(75) Inventor: Leo Medeiros, Guelph (CA)

Correspondence Address: CARLSON, GASKEY & OLDS, P.C., 400 WEST MAPLE ROAD, SUITE 350, BIRMINGHAM, MI, 48009, US

(73) Assignee: Meritor Suspension Systems Company, U.S.

(21) Appl. No.: 11/221,441

(22) Filed: Sep. 8, 2005

(51) Int. Cl. B60G 11/18; B60G 21/055

(52) U.S. Cl. 280/124.137; 280/124.107

(57) ABSTRACT

A vehicle suspension component includes a first suspension member having a connection portion for connection to a second suspension member. A retention member is formed on the first suspension member near the connection portion for resisting relative lateral movement between the first suspension member and the second suspension member. The retention member is formed in a band shape partially or completely around the first suspension member.

### BACKGROUND OF THE INVENTION

This invention relates to vehicle suspensions and, more particularly, to a kinetically deposited retention feature for resisting relative movement between a stabilizer bar and a bushing that results from external suspension forces on the stabilizer bar.

Vehicles are commonly equipped with suspension systems for absorbing weight shock and other vibrations, while providing for a smooth and comfortable ride. A suspension component, such as a stabilizer bar, is often used to increase roll rigidity and improve the standard stability of the vehicle. Conventionally, the stabilizer bar is attached to the lower A arms of the suspension system to control sway as the vehicle turns by providing an opposing push-up and pull-down force during cornering.

As the vehicle turns, the body of the vehicle rolls to the outside of the turn. The suspension components on the outside of a turn are generally compressed, while the suspension components on the inside of the turn are generally extended. The stabilizer bar counters this motion by pushing up on the suspension components collapsed and compressing the suspension components expanded through torsion in the stabilizer bar.

The stabilizer bar is typically connected to a vehicle frame by a pair of brackets. Bushings are disposed within each of the brackets between the stabilizer bar and the bracket to permit rotation of the stabilizer bar during turning maneuvers. Undesirably, the stabilizer bar tends to move laterally within the bushings during rotation of the stabilizer bar.

Conventionally, retention rings have been used on the stabilizer bar to engage each of the bushings and resist lateral movement of the stabilizer bar. As the stabilizer bar rotates during turning of the vehicle, the retainer rings contact the bushings to resist lateral movement of the stabilizer bar. Disadvantageously, retainer rings are bulky and may interfere with adjacent components. Further, retention rings often require laborious assembly steps and may loosen or break over time.

Alternatively, the stabilizer bar includes a bend next to each of the bushings that functions similarly to the retention ring to resist stabilizer bar movement. The bends are typically also bulky and require labor intensive steps that may add expense to the suspension system.

Accordingly, a simplified, compact, and strong retention feature that does not loosen from the stabilizer bar is needed.

### SUMMARY OF THE INVENTION

A vehicle suspension component according to the present invention includes a first suspension member having a connection portion for connection to a second suspension member. A retention member is formed on the first suspension member near the connection portion for resisting relative lateral movement between the first suspension member and the second suspension member.

A method of forming a retention member on a stabilizer bar according to the present invention includes kinetically depositing a powder on the stabilizer bar. In one example, the method includes a step of depositing the powder on the stabilizer bar at a temperature that is less than melting temperature of the powder.

A method of stabilizing a suspension component according to the present invention includes forming a retention member on a stabilizer bar near a connection between the stabilizer bar and a bushing to resist relative lateral movement between the stabilizer bar and the bushing.

Accordingly, the vehicle suspension component of the disclosed examples provides a simplified, compact, and strong retention member while avoiding the shortcomings and drawbacks of the prior art. These and other features of the present invention will be best understood from the following specification and drawings.

### BRIEF DESCRIPTION OF THE DRAWINGS

The various features and advantages of this invention will become apparent to those skilled in the art from the following detailed description of the currently preferred embodiment. The drawings that accompany the detailed description can be briefly described as follows.

FIG. 1 is a schematic perspective view of a suspension member of a vehicle suspension system.

FIG. 2 schematically illustrates a retention member abutting a bushing mounted on the suspension member.

FIG. 3 schematically illustrates a retention member band about a suspension member.

FIG. 4 schematically illustrates first and second extended portions from a suspension member.

FIG. 5 schematically illustrates a step of kinetically depositing a powder on a suspension member.

FIG. 6 schematically illustrates a method of building up a powder on a suspension member to form a retention member.

FIG. 7 schematically illustrates further building-up of powder on a suspension member.

FIG. 8 schematically illustrates removal of retention walls after a build-up of powder on the suspension member.

### DETAILED DESCRIPTION OF THE PREFERRED EMBODIMENT

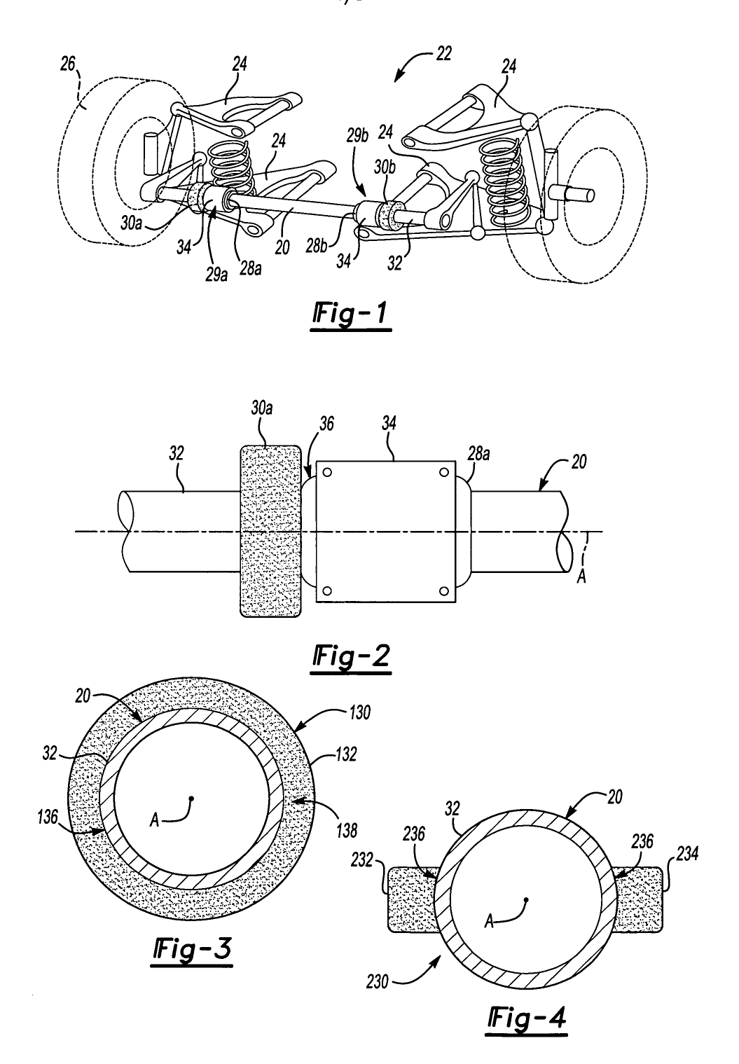

FIG. 1 illustrates a suspension member 20, such as a stabilizer bar, of a vehicle suspension system 22. In this example, the suspension member 20 is attached to control arms 24, which are connected to wheels 26. A pair of bushings 28a and 28b are respectively received over connection portions 29a and 29b of the suspension member 20. As the suspension member 20 deflects during turning, the suspension member 20 rotates within the bushings 28a and 28b.

In this example, retention members 30a and 30b are formed on an outer surface 32 of the suspension member 20 adjacent to a wheel side of each of the bushings 28a and 28b, respectively. A bracket 34 is received over each of the bushings 28a and 28b for connection of the suspension member 20 to a vehicle frame (not shown). Although FIG. 1 illustrates the retention members 30a and 30b positioned adjacent to the wheel side of the bushings 28a and 28b, respectively, it is to be understood that the retention members 30a and 30b can also be positioned adjacent to the opposite sides of each of the bushings 28a and 28b, respectively.

In the example illustrated in FIG. 2, the retention member 30a abuts against a wheel-side portion 36 of the bushing 28a. This provides the benefit of resisting relative lateral movement along an axis A between the suspension member 20 and the retention member 30a. Likewise, the retention member 30b abuts the bushing 28b to resist lateral movement between the suspension member 20 and the retention member 30b.

FIG. 3 illustrates an example first embodiment retention member 130. The retention member 130 includes a band 132 that extends about the suspension member 20. In the illustration, the band 132 extends all the way around a circumference of the suspension member 20, however, it is to be recognized that the band 132 can also extend only partially around the circumference.

The band 132 is formed on the outer surface 32 in a deposition process. In one example, the retention member 130 is kinetically deposited onto the outer surface 32 from a stock of powder. Preferably, the powder is a metal, composite, metal-alloy, or ceramic material. The term “kinetically deposited” as used in this description refers to the process of depositing a powder by accelerating powder particles to a relatively high velocity at temperatures below the melting point of the powder. The powder particles traveling at relatively high velocities impact the outer surface 32 of the suspension component 20, or impact other powder particles that have already been deposited. The impact mechanically bonds the powder particles to the outer surface 32 or other powder particles. In one example, the powder is accelerated through a known convergent-divergent nozzle, also known as a deLaval nozzle.

In the illustrated example, the band 132 is bonded to the outer surface 32 of the suspension member 20 at a kinetic bond 136. The kinetic bond 136 includes an interface between a central portion 138 of the band 132 and the outer surface 32. The kinetic bond 136 secures the band 132 to the suspension member 20 such that when the retention member 130 abuts against a bushing (e.g., bushing 28a or 28b), the band 132 resists movement of the bushing relative to the suspension member 20.

FIG. 4 illustrates an example second embodiment retention member 230. In this example, the retention member 230 includes a first extended portion 232 and a second extended portion 234. The first extended portion 232 and the second extended portion 234 extend outwardly from the outer surface 32 of the suspension member 20. Each of the first extended portion 232 and the second extended portion 234 is kinetically bonded at a kinetic bond 236 to the outer surface 32 of the suspension member 20, as described above for the previous example.

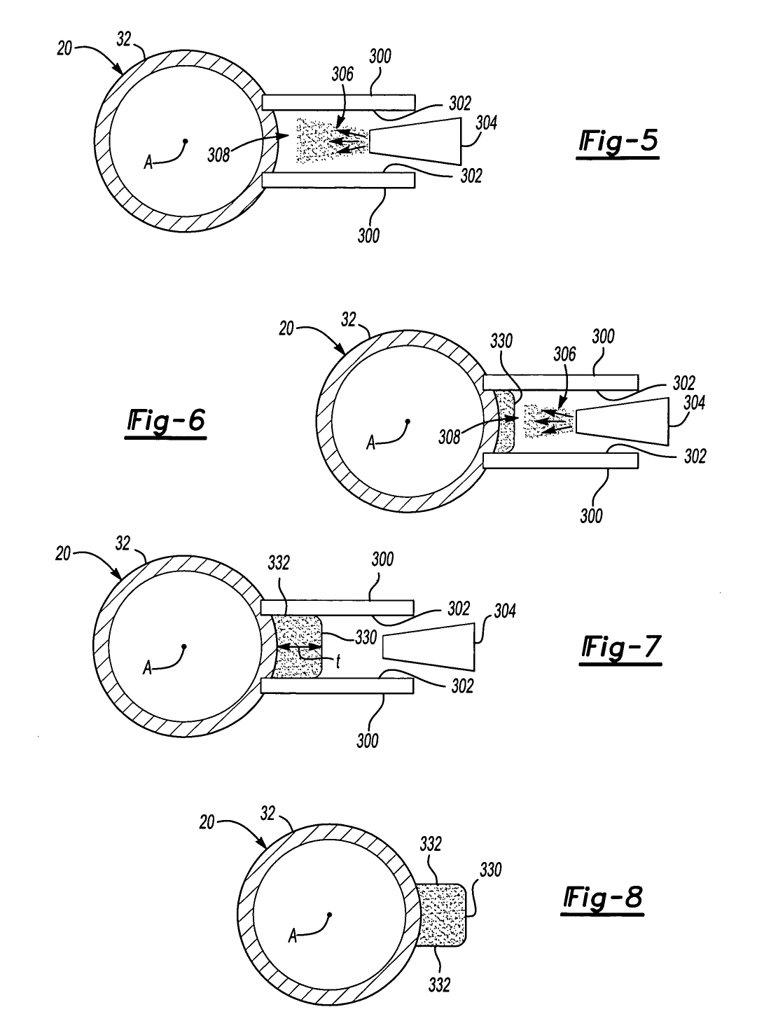

FIG. 5 illustrates an example method of forming a retention member on the suspension member 20. In this example, the forming process occurs after a heat treatment of the suspension member 20. Alternatively, the forming process occurs after a cold forming of the suspension member 20. In the illustration, retaining walls 300 are positioned adjacent to the suspension member 20. In the illustration, the retaining walls 300 includes flat inner surfaces 302.

During formation of a retention member, a nozzle 304 is positioned near the retaining walls 300 to spray, for example, a powder 306 into a space 308 within the retaining walls 300 and on the outer surface 32 of the suspension member 20.

Referring to FIG. 6, the powder 306 is kinetically deposited into the space 308 to gradually build-up the retention member 330 on the outer surface 32. In one example, the gradual build-up takes place over time as opposed to depositing the entire retention member 330 in a single “shot.”

Referring to FIG. 7, the powder 306 is kinetically deposited into the space 308 until a desired thickness t of the retention member 330 is achieved. The nozzle 304 and suspension member 20 can be held static to produce the retention member 330 in a shape similar to either extended portions 232 or 234 in FIG. 4. Alternatively, the nozzle 304 can be rotated about the suspension member 20 or the suspension member 20 can be rotated about the axis A to produce a band shape similar to FIG. 3. In one example, the thickness is controlled by kinetically depositing the powder 306 for a predetermined amount of time at a predetermined deposition rate. As is known, the deposition rate corresponds to the nozzle geometry, particles size, particle flow rate, or other deposition parameters for example.

In the illustrated example, the retaining walls 300 form essentially flat surfaces 332 of the retention member 330. This provides the desirable feature of a relatively smooth and flat surface against which a bushing (e.g., bushing 28a or 28b) abuts to resist relative movement between the retention member 330 and the suspension member 20. Although two distinct walls 300 are shown, it is to be understood that a single retaining wall 300 may alternatively be used to produce the retention member 330 with a different contour on each side. Alternatively, no retaining walls 300 may be used to produce the retention member 330 with “rough” surfaces.

Referring to FIG. 8, after the retention member 330 has been deposited on the outer surface 32 of the suspension member 20, the retaining walls 300 are removed and the retention member 330 remains. In one example, the retention member 330 includes a bond strength of at least 2,000 N to the suspension member 20. This provides the benefit of the retention member 330 remaining securely fixed to the suspension member 20 and not becoming loose as the retention member 330 and bushing 28a, for example, press against each other during operation of the vehicle.

Although a preferred embodiment of this invention has been disclosed, a worker of ordinary skill in this art would recognize that certain modifications would come within the scope of this invention. For that reason, the following claims should be studied to determine the true scope and content of this invention.

I claim:

1. A vehicle suspension component comprising:
a first suspension member including a connection portion for connection to a second suspension member; and
a retention member formed on said first suspension member near said connection portion for resisting relative lateral movement between said first suspension member and said second suspension member.

2. The component as recited in claim 1, wherein said first suspension member comprises a stabilizer bar and said connection portion comprises a bushing.

3. The component as recited in claim 1, wherein said retention member comprises a band formed about said first suspension member.

4. The component as recited in claim 3, wherein said band is kinetically bonded to said first suspension member.

5. The component as recited in claim 1, wherein said first suspension member defines a lateral axis and said retention member comprises a first portion that extends outwardly from said first suspension member in a direction transverse to said longitudinal axis.

6. The component as recited in claim 1, wherein said retention member extends at least partially about an outer peripheral surface of said first suspension member.

7. The component as recited in claim 1, further comprising a kinetic bond between said retention member and said first suspension member.

8. The component as recited in claim 7, wherein said kinetic bond includes a bond strength of at least 2000N.

9. The component as recited in claim 1, wherein said retention member is kinetically deposited onto an outer surface of said first suspension member.

10. A method of forming a retention member on a stabilizer bar, comprising:
kinetically depositing a powder on a stabilizer bar to form a retention member.

11. The method as recited in claim 10, including kinetically depositing the powder on the stabilizer bar at a temperature that is less than a melting temperature of the powder.

12. The method as recited in claim 10, including kinetically depositing the powder to gradually build-up a desired thickness of powder on the stabilizer bar.

13. The method as recited in claim 10, including kinetically depositing the powder adjacent to a retaining wall having a retaining wall shape formed to achieve a desired deposited-powder shape that corresponds to the retaining wall shape.

14. The method as recited in claim 13, including removing the retaining wall after kinetically depositing the powder.

15. A method of stabilizing a suspension component, comprising:
forming a retention member on a stabilizer bar near a connection between the stabilizer bar and a bushing to resist relative lateral movement between the stabilizer bar and the bushing.

16. The method as recited in claim 15, including kinetically depositing a powder adjacent to the connection to form the retention member.

17. The method as recited in claim 15, including abutting the retention member against the bushing to resist relative axial movement between the retention member and the bushing along a lateral axis defined by the bushing.

18. The method as recited in claim 15, including heat treating the stabilizer bar before forming the retention member.

19. The method as recited in claim 15, including forming the retention member at least partially about an outer peripheral surface of the stabilizer bar.

20. The method as recited in claim 19, including forming the retention member in a band about the stabilizer bar to completely surround the outer peripheral surface.
